(19) United States
(12) Patent Application Publication
(10) Pub. No.: US 2009/0130633 A1
(43) Pub. Date: May 21, 2009

(54) SYSTEM AND METHOD FOR MANAGING DATA RELATING TO DENTAL PRODUCTS AND MANUFACTURING PROCESSES

(76) Inventors: Michael A. Kraemer, Landsberg am Lech (DE); Bernd Gangnus, Herrsching (DE); Berthold G. Reusch, Lexington, MA (US)

Correspondence Address: 3M INNOVATIVE PROPERTIES COMPANY, PO BOX 33427, ST. PAUL, MN, 55133-3427, US

(21) Appl. No.: 12/159,267

(22) PCT Filed: Dec. 28, 2006
(86) PCT No.: PCT/US06/49425

§ 371 Date: Oct. 20, 2008

Related U.S. Application Data
(60) Provisional application No. 60/755,662, filed on Dec. 30, 2005.

(51) Int. Cl. A61C 13/20; G06F 15/16; H04L 9/00; G06F 17/40; G06Q 40/00; G06F 19/00; G06F 17/30

(52) U.S. Cl. 433/201.1; 709/219; 713/150; 713/151; 707/10; 705/39; 700/159; 707/E17.044

(57) ABSTRACT

A system and method for managing data used for manufacturing dental prostheses in a system having a plurality of scanning sites and a plurality of machining sites connected to at least one central unit. The central unit receives data from at least one of the scanning sites and assigns the data received from the scanning site to one of the machining site and transmits the assigned data to the machining site. The at least one scanning site and the plurality of machining sites are geographically remote from each other and from the central unit and at least one scanning site and the plurality of manufacturing sites are connected to the central unit via a telecommunication and/or computer network.

### CROSS-REFERENCE TO RELATED APPLICATION

This application claims the benefit of U.S. Patent Application Ser. No. 60/755,662, filed Dec. 30, 2005.

### FIELD OF THE INVENTION

The present invention is related to systems and methods for manufacturing dental prostheses, such as bridges and crowns. In particular, the present invention is directed to novel methods for managing the processing of scan or design data used for manufacturing dental prostheses in a system having a plurality of machining devices.

### BACKGROUND OF THE INVENTION

Prostheses are commonly used in the dental industry for replacing or reconstructing teeth. Generally, such dental prostheses can be in the form of implants, abutments, crowns, bridges, onlays and inlays. Since such prostheses have to be designed precisely in order to ensure proper fit, manufacturing methods for such products have to meet certain criteria in terms of accuracy in designing and machining. It is recognized in the art that computer aided design (CAD) and computer aided manufacturing (CAM) can be viable options for providing flexibility, ease and accuracy in designing and manufacturing such prostheses.

For example, U.S. Pat. No. 6,287,121 describes a device for determining the shape of a duplicate of a remaining tooth area to be provided with a dental prosthesis and an arrangement for producing the dental prosthesis. The described arrangement for producing the prosthesis comprises a shape determination device and a machining device for the actual production of the dental prosthesis, and an electronic data processing (EDP) installation. The EDP installation couples the shape determination device with the machining device, and also includes a memory unit for the results of the shape determination device, and a control unit for controlling the machining device. U.S. Pat. No. 6,287,121 primarily relates to a three serial module arrangement consisting of the shape determination device, EDP installation and machining device. All control and monitoring functions take place in the EDP installation, so that the shape determination device and the machining device need not have individual EDP units. This provides central control and monitoring of the entire production of the dental prosthesis at the EDP installation. Such an arrangement may be efficient for cases where only one machining device is needed.

WO 01/37756 discloses an arrangement for a system for manufacturing dental products having a plurality of production units. The manufacturing system comprises various coordination units which receive and register orders from different customers. The coordination units distribute the orders to production units. The various units are updated by data replications in conjunction with changes to system functions, system application and system structure. The data contained in the databases of the production units are entered in memory elements which are arranged for accessing program contents when executing data replications via one or more interfaces. In the arrangement described, a production job for a particular dental product is assigned to a particular production unit by one of the coordination units. The data is then replicated from the coordination unit to that particular production unit.

WO 98/44865 relates to an arrangement and system for production of dental products and transmission of information. An operating site is used to assemble individually designed dental products, for example distancing pieces, bridges, etc. Each product consists of two or more structural elements. The operating site is provided with computer equipment which can reproduce a simulated model of the jaw, dentine, implant, etc., and structural elements applied to the model. The operating site is arranged to collate data in a query profile relating to part of the assembly. Members are included for transmitting query profile data via the network to the central unit. The central unit supplies information relating to the part in question. The information is sent to the operating site or to a production unit connected to the central unit for production of the part. A debiting system is arranged to indicate to the central unit or to the production site that the information or production, respectively, has been paid for.

EP-A-1 088 526 relates to a method and apparatus for the manufacturing of dental restorations. The manufacturing method for a dental restoration comprises, in addition to the process steps known in the art, the step of at each step registering information about the status of the restoration. A manufacturing apparatus for performing the inventive method may comprise: a reading unit for registering geometrical data about the restoration to be manufactured, a design unit for creating a digital model of the restoration and/or manual adaptation of the model, a calculating unit for calculating the tool paths corresponding to the model, a production unit for producing the restoration using the data calculated for the tool paths, and means for registering information about the actions of each unit regarding one particular restoration.

US 2002/0102520 relates to a process for preparing a dental prosthesis. To overcome the difficulty in designing a dental prosthesis, a measuring center stores three-dimensional coordinate information of an intra-oral shape measured by impression taking or by photographing within an oral cavity of a patient, as a digital signal and sends the obtained measure data to a design center using communication means; the design center reproduces the intra-oral shape on a graphic display device based on the received measuring data by means of a three-dimensional graphic, designs a shape of a dental prosthesis and stores it as a digital signal, and then sends the obtained design data of the dental prosthesis to a processing center using communication means; and the processing center transmits the received design data to a milling process or as a processing command and subjects a block material to milling processing to prepare a dental prosthesis.

Hence, there is a need for a more flexible method and system for manufacturing dental prostheses in an environment having a plurality of production devices at different geographical locations.

### SUMMARY OF THE INVENTION

The present invention provides a system and a method for manufacturing dental prostheses. The method is particularly suitable for use in a manufacturing process in which a plurality of scanning sites and a plurality of machining devices are situated at geographically different locations.

According to a first aspect of the invention, a method for managing data relating to dental products or dental situations for manufacturing dental prostheses is provided (as used herein the term “data” also includes sets of data). This data management method is useful in a system having a plurality of scanning sites and a plurality of machining sites connected to one or more central units. The method comprises the steps of: receiving at the central unit the data relating to a dental product or situation from at least one of the scanning sites; assigning the data received at the central unit from the scanning site to one of the machining sites; and transmitting the assigned data to the machining site for processing.

In another embodiment the method may comprise the steps of: receiving at the central unit the data relating to a dental product or situation from at least one of the scanning sites; assigning the data received at the central unit from the scanning site to at least two of the machining sites; and transmitting the assigned data to the at least two machining sites for processing. Further, the method may comprise a step of processing the data received from the at least one of the scanning sites in the central unit. Such processing may include at least one of adding data (for example [ . . . ]), modification of data (for example [ . . . ]) and selecting specific data from the data received, for example.

Typically, the data transfer (meaning for example receiving data and transmitting data) involves data encryption. The data encryption may comprise encryption of data prior to receiving or transmitting, for example at least a part of the data as such may be encrypted before they are transferred. Such encryption may include the use of DES (Data Encryption Standard) or Triple DES, or any other suitable encryption method. Further, the data encryption may comprise the use of encrypted data transfer protocols, for example S-HTTP (Secure Hypertext Transfer Protocol) or HTTPS (Hyper Text Transfer Protocol Secure).

The scanning site(s) and the machining site(s) are typically geographically remote from each other and from the central unit.

Typically, the data relating to dental products or dental situations received from the scanning site(s) is stored in a storage unit of the central unit. After the data is assigned to a machining site, the data can be retrieved from the central unit storage and saved in a storage unit of the machining site before machining starts.

Whenever a machining site is free, i.e. is not in the process of manufacturing a dental prosthesis, it may draw data from the central unit from the plurality of available data or data sets for further processing.

Preferably, the data received from the scanning site(s) includes instructions to assign the received data to a specific machining site that is preferred by the scanning site. For example, the scanning site may select a specific machining site based on lowest price, delivery time, or the like.

The data exchange between the scanning sites and the central unit, on the one hand, and the central unit and the machining sites, on the other hand, is preferably done using a telecommunication and/or computer network such as the internet, or by email.

The method preferably comprises the step of charging the machining site for the sending of data to the selected machining site. Since the central unit gathers data and data sets from the various scanning sites connected to the central unit, the machining sites can be charged for such collection of data/data sets, and for providing such data/data sets to the machining sites. It is also encompassed by the present invention that this charge is already covered with the sale of the material needed to manufacture the restoration at the machining site. This is particularly advantageous if the central unit is operated by the material manufacturer. Furthermore, the concept of the present invention is not limited to the sale of scan data but may be applied to any goods needed for the overall process at both the scanning and the milling sites, such as tools for milling.

The data or data sets are preferably scan data, X-ray data, shade information data, intraoral image data, bite registration data, or information data on the mandibular joint. According to the present invention, scanned data or framework data are sent from the scanning sites to the central unit, i.e. data in a state prior to the CAD/CAM (computer-aided design/computer-aided manufacturing) step. The CAD/CAM step can be performed at the machining sites, where the final machining sequences are calculated.

According to a second aspect, the present invention provides a central unit for managing data relating to dental products or dental situations, which data is used in a dental manufacturing system having a plurality of scanning sites and a plurality of machining sites connected to one or more of such central units. The central unit comprises a receiving unit for receiving the data from at least one of the scanning sites; a processing unit for assigning at the central unit one of the machining sites to the particular data or data set received from the at least one scanning site; and a transmission unit for forwarding the assigned data or data set to the assigned machining site for processing. Typically, the scanning site(s) and machining site(s) are geographically remote from each other and from the central unit.

Preferably, the central unit further comprises a storage unit for storing the data or data sets relating to dental products or situations in a storage of the central unit.

According to a further preferred feature, the central unit debits to the machining site the sending of data or data sets to this specific machining site. It is further preferred to debit the scanning sites for receipt, storage and transmission of data sets.

According to a further preferred feature, storage of any data linked with the manufacture of a certain prosthesis until all financial transactions between involved parties, patient, dentist, lab, scanning site, manufacturing site, central unit provider, and perhaps a health care insurance, are finalized is encompassed within the present invention. For example, any process information from the central hub can be forwarded to health care insurance agencies (in countries where supplying such data is required and is legal).

According to a further aspect of the present invention, a system for managing data or data sets relating to dental products or dental situations for manufacturing dental prostheses is provided. The system comprises at least one central unit; at least one scanning site having a data processor configured for designing a framework of a dental prosthesis using a digital image of a scanned situation of a person's teeth area; and a plurality of machining sites for manufacturing dental prostheses; wherein the at least one scanning site and the plurality of machining sites are geographically remote from each other and from the central unit; and wherein the at least one scanning sites and the plurality of manufacturing sites are connected to the central unit via a telecommunications and/or computer network.

In the system according to the present invention, each scanning site comprises at least one workstation having the data processor configured for designing a dental prosthesis using a digital image of a situation of a person's teeth area. Preferably, the scanning site data processor is configured to generate machining data having content for providing machining path instructions for forming the framework at a machining site. Furthermore, the scanning site comprises at least one scanner for producing a digital image of a situation of a person's teeth area. The scanner can produce a digital image of the situation of a person's teeth by directly scanning an area of a person's teeth or by scanning a working model of an area of a person's teeth. The situation of a person's teeth area refers to the area of the person's teeth in which the dental prosthesis should be placed. In the case where a working model is scanned, a working model is provided by a dentist, a dental technician, or other customer, for example. The working model is normally based on an impression made from an area of a person's teeth in which the dental prosthesis should be placed. The working model is preferably placed within the scanner where a digital image is made of the working model. The digital image representing the working model is received by the data processor of a workstation. Preferably, the data processor uses a CAD/CAM modeling software, such as Lava™ System (commercially available from 3M-ESPE AG, Seefeld, Germany) to design a framework for the dental prosthesis using the digital image as a basis.

Furthermore, a machining site comprises a machining device for machining the framework for the dental prosthesis from a material blank using machining data generated at least one workstation of a scanning site. A machining site may also comprise a machining device providing for making the framework for the dental prosthesis by use of a build-up technique using machining data generated at least one workstation of a scanning site. Each machining device comprises a data processor having a storage unit for storing machining data files and preferably a receiving unit for receiving a plurality of material units.

The machining site may comprise any suitable machining device that provides appropriate machining of the material blank to form the framework for a dental prosthesis. Such machining devices may include milling devices, grinding devices laser devices and the like. In case a build-up technique is used, such machining devices may use rapid prototyping techniques like stereo lithography, 3D printing, laser sintering, laminated object manufacturing, or any other suitable technique. The machining device is preferably configured to machine the material blank according to the instructions in the machining data file(s) in order to form a dental prosthesis. Preferably, the machining device is so configured that a plurality of material units can be loaded, and finished material units for dental prostheses can be removed while machining continues.

Preferably, the machining site is configured to first save the machining data file in the storage unit of the machining device and then machine the material blank as the machining data file is read from its own storage unit. This is particularly advantageous in that the machining is performed independent of the central unit storage. For instance, if the central storage means was disabled, it would not affect the machining process of a blank being instantaneously machined. After the machining of the blank is complete, the corresponding machining data file is preferably deleted from the central unit storage and the storage unit of the machining device.

For each dental prosthesis to be designed and machined, a machining job is established for machining the framework for the dental prosthesis. The machining job is represented electronically by machining data comprised in a machining data file or files, i.e. the data sets. The machining data indicates the machining path instructions and the material unit assigned to that machining job. The machining path instructions are based on the desired parameters for the prosthesis and the material characteristics of the material blank. The machining path instructions can be determined using CAD/CAM software.

Preferably, the central unit assigns one of the machining sites to a particular data or data set received from the at least one scanning site.

It is also preferred that the central unit further comprises a storage unit for storing the data or data sets relating to dental products or situations for manufacturing dental prostheses received from the at least one scanning site, wherein once the data or data sets are assigned to a specific machining site, the machining site is configured to retrieve the machining data or data sets from the central storage.

For manufacturing the dental prosthesis, a material blank is typically used. The material blank can be any biocompatible material that is suitable for use in dental prosthetic applications. For example, suitable biocompatible materials may comprise polymer-based materials, precious metals and titanium. Preferably, the material blank is a pre-sintered ceramic, such as pre-sintered zirconium oxide or zirconia, respectively.

Thus, according to the present invention, the data or data sets relating to dental products or situations are preferably generated by dental laboratories or dental offices that typically only have a scanner with an associated workstation, and optionally a design software for designing a virtual dental prosthesis. With the present invention, such dental laboratories are in a position to access a central hub, i.e. the central unit, and send their data to the central unit. This is advantageous for the dental laboratories as they are independent from a specific milling center. On the other hand, the decentralized milling centers run by individual companies which are not necessarily equipped with scanning equipment are in a position to access the collection of data or data sets at the central unit in order to manufacture dental replacements. This is advantageous for the milling centers as they do not have to provide the networking infrastructure themselves. It is, therefore, possible to avoid backlog at specific milling centers because the orders placed by the dental laboratories can be distributed to the various milling centers in a balanced manner. This is particularly helpful in case of geographically distinct scanning sites and milling sites.

The central unit is preferably provided by the material manufacturer. This allows the material manufacturer to maintain at least some control on the whole production process and the individual parties involved. Furthermore, the central unit is the critical part since the whole process depends on the availability and reliability of the central unit. For this reason, it is preferred that the central unit is operated by the brand owner in order to guarantee the full-time availability, i.e. 24 hours, 7 days a week, to receive scan data and to provide them to the milling sites.

Typically, the machining sites and scanning sites are run by individual companies. This is in contrast to known approaches where the milling centers are run by the equipment and/or material manufacturer itself. In this respect, the present invention is advantageous because the equipment and/or material manufacturer and owner of a corresponding brand or trademark does not have to operate the milling sites which allows to have multiple decentralized milling centers.

As used herein, “a” or “an” means “at least one” or “one or more” unless otherwise indicated. In addition, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

Unless otherwise indicated, all numbers expressing quantities of ingredients, measurement of properties such as contrast ratio and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

With regard to the various described aspects of the invention, it should be noted that the method steps do not have to be in the specific order described in the preferred embodiments and FIGURE.

### BRIEF DESCRIPTION OF THE DRAWING

A preferred embodiment of the present invention will be further described by the following description and drawing:

FIG. 1 is a diagram of a system according to an embodiment of the present invention.

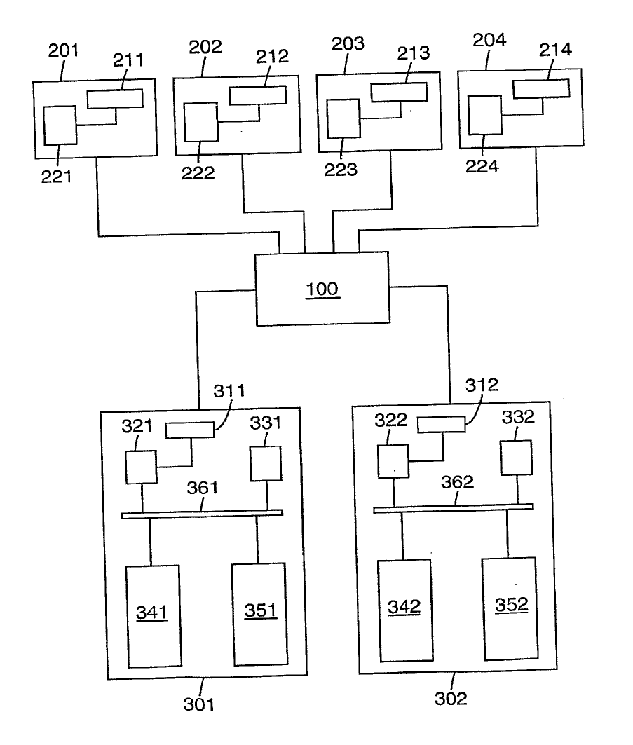

### DETAILED DESCRIPTION

Referring to the FIGURE, the system using the method of the present invention generally comprises at least one central unit 100. A plurality of scanning sites 201, 202, 203, 204 and a plurality of machining or milling sites 301, 302 are connected to the central unit 100 forming a network.

Each scanning site 201, 202, 203, 204 preferably comprises a scanner 211, 212, 213, 214 being connected to a processing system such as a workstation or personal computer 221, 222, 223, 224.

The scanners 211, 212, 213, 214 are configured to scan a model representing the area of a person's teeth in which the dental prosthesis should be placed and to form a digital image of the model. The scanner are preferably non-contact 3-D optical scanners.

The workstations 221, 222, 223, 224 each typically comprise an electronic data processor. Preferably, the workstation is a computer having storage means, a data processor, a monitor, a keyboard, and a mouse and/or touchpad or the like. The data processor of the workstations is configured to store and process digital images received from a scanner or other external source. Other external sources could include digital images of situations of teeth received via modem, network or read from external storage media. The digital images are processed using CAD/CAM software for designing dental prostheses and for determining the milling data. For example, the dental prosthesis can be designed using a CAD modeling software such as Lava™ System (commercially available from 3M ESPE AG, Seefeld, Germany). For each dental prosthesis to be designed and milled, a milling job is established for milling the framework for the dental prosthesis. The milling job is represented electronically by milling data comprised in a milling data file or files. The milling data file indicates the milling path instructions and the material blank assigned to that milling job. The milling path instructions are based on the desired parameters for the prosthesis and the material characteristics of the material blank. Preferably, the milling path instructions are determined using the CAM software, for example LAVA™ CALC software (commercially available from 3M-ESPE AG, Seefeld, Germany).

The material blank for the dental prosthesis is typically a biocompatible material. Suitable materials include ceramics, precious and non-precious metals or metal alloys, resins or resin based composite materials, including fiber-reinforced composites. Preferably, the material blank consists of a pre-sintered ceramic material. Most preferably, the material blank consists of pre-sintered zirconium oxide. The material blank may be in any suitable form for milling. For example, the material blank may be in the form of a cylindrical solid block.

The machining or milling sites 301, 302 preferably comprise at least one machining or milling device 341, 351, 342, 352. The one or more milling devices are connected to a works station or computer 331, 332 via a local network such as bus 361, 362. As shown in the FIGURE, the milling sites 301, 302, may each optionally also comprise a scanner 311, 312 for scanning a model representing the area of a person's teeth in which the dental prosthesis should be placed, as described above. The scanners 311, 312 are connected to the local network via a workstation or computer 321, 322.

The machining or milling devices 341, 351, 342, 352 mill the material blank in order to form the framework of the dental prosthesis. The milling devices are typically configured to receive a plurality of material blanks, for example in a loading area or the like. Each milling device has a data processing means including a storage unit for storing milling data files and reading means for reading an identification code of the material blank. The milling data file contains milling path instructions for the milling devices.

In the following, a preferred method according to the present invention is described. In this preferred embodiment, the milling data files generated by the scanners 211, 212, 213, 214 and workstations 221, 222, 223, 224 are sent to and stored in the central unit 100 as shown in the FIGURE. For example, the central unit 100 could be a network attached server or the like. Each milling center 301, 302 has access to the unit 100, thereby being able to save to, retrieve from or delete files from the storage of central unit 100. Once a milling device 341, 351, 342, 352 is free to take over a new milling job, the milling sites 301, 302 are configured to access the central unit 100 in order to obtain a new milling data file from the central unit 100. The milling device 341, 342, 351, 352 then mills the framework of the prosthesis from the material blank, as the milling data file is being read from the central unit 100. After the framework for the dental prosthesis has been milled, the milling data file is then preferably deleted from the central unit 100. This aspect of the invention is particularly advantageous in that the milling data file does not have to be previously assigned at the scanning site 201, 202, 203, 204 to a particular milling site 301, 302.

Alternatively, the milling site 301, 302, is configured to first save the milling data file in the storage unit of the associated workstation and then mill the material blank as the milling data file is read from its own storage unit. This is particularly advantageous in that the milling is performed independent of the central unit 100. After the milling of the blank is complete, the corresponding milling data file is preferably deleted from the central unit 100 and the storage unit of the milling site 301, 302.

The various embodiments presented in the specification are used for the sake of description and clarification of the invention, and thus should not be interpreted as limiting the scope of the invention as such. Moreover, the present invention is realized by the features of the claims and any obvious modifications thereof.

1. A method for managing data used for manufacturing dental prostheses in a system having a plurality of scanning sites and a plurality of machining sites connected to at least one central unit, the method comprising the steps of:
receiving data at the central unit from at least one of the scanning sites;
assigning the data received from the scanning site at the central unit to a machining site; and
transmitting the assigned data to the machining site.

2. The method of claim 1, wherein the data received from the scanning site are assigned to at least two machining sites and the assigned data are sent to the at least two machining sites.

3. The method of claim 1, wherein receiving and transmitting involves data encryption.

4. The method of claim 3, wherein data encryption comprises encryption of data prior to receiving and transmitting.

5. The method of claim 3, wherein data encryption comprises the use of encrypted data transfer protocols.

6. The method of claim 1, wherein the scanning sites and the machining sites are connected to the central unit via a telecommunications and/or computer network.

7. The method of claim 1, further comprising the steps of:
storing the data in a storage unit of the central unit; and
after the data is assigned to the machining site, retrieving the data from the central unit storage and saving the data in a storage unit of the machining site before commencing machining.

8. The method of claim 7, further comprising a step of processing the data received from the at least one of the scanning sites in the central unit.

9. The method of claim 8, wherein processing of the data received from the at least one of the scanning sites includes at least one of adding data, modifying of data and selecting specific data from the data received.

10. The method of claim 7, wherein a free machining site draws the stored data from the central unit for further processing.

11. The method of claim 1, wherein said data received from the scanning site includes instructions to assign the received data to a specific machining site.

12. The method of claim 1, further comprising the step of debiting to the machining site the sending of data or to this specific machining site.

13. The method of claim 1, wherein the data comprises scan data, X-ray data, shade information data, intraoral image data, bite registration data, or information data on the mandibular joint.

14. The method of claim 1, wherein the data comprises data sets relating to dental products or dental situations.

15. A central unit for managing data used for manufacturing dental prostheses in a system having a plurality of scanning sites and a plurality of machining sites connected to the central units comprising:
a receiving unit for receiving the data from at least one of the scanning sites;
a processing unit for assigning the particular data or data set received from the scanning site at the central unit to a machining site; and
a transmission unit for forwarding the data to the assigned machining site for processing.

16. The central unit of claim 15, wherein the scanning sites and the machining sites are connected to the central unit via a telecommunications and/or computer network.

17. The central unit of claim 15, further comprising a storage unit for storing the data in the central unit.

18. The central unit of claim 15, wherein the central unit is capable of debiting to the machining site the sending of data to the machining site.

19. The central unit of claim 15, wherein the data comprises data sets relating to dental products or situations.

20. A system for managing data used for manufacturing dental prostheses comprising:
at least one central unit;
at least one scanning site having a data processor configured for designing a framework of a dental prosthesis using a digital image of a scanned situation of a person's teeth area; and
a plurality of machining sites for manufacturing dental prostheses;
wherein the at least one scanning site and the plurality of machining sites are geographically remote from each other and from the central unit; and
wherein the at least one scanning site and the plurality of manufacturing sites are connected to the central unit via a telecommunications and/or computer network.

21. The system of claim 20, wherein the scanning site data processor is configured to generate machining data having content for providing machining path instructions for forming the framework at a machining site.

22. The system of claim 20, wherein the system is configured to delete the machining data after the dental prosthesis is machined.

23. The system of claim 20, further comprising at least one scanner for producing a digital image of a situation of a person's teeth area.

24. The system of claim 20, wherein the central unit assigns a machining site to data received from the at least one scanning site.

25. The system of claim 24, the central unit further comprising a storage for storing the data relating to dental products or situations for manufacturing dental prostheses received from the at least one scanning site, wherein after the data are assigned to a specific machining site, the machining site is configured to retrieve the machining data from the central storage.

26. The system of claim 20, wherein after machining of the dental prosthesis is complete, the machining site is configured to request a deletion of the machining data corresponding to the dental prosthesis from the central unit storage.

27. The system of claim 20, wherein the data comprises data sets relating to dental products or situations
